(19) United States
(12) Patent Application Publication
(10) Pub. No.: US 2021/0368992 A1
(43) Pub. Date: Dec. 2, 2021

(54) Knock Down Sectional Couches and Related Wedge Sections and Methods

(71) Applicant: Handy Button Machine Co., Wheeling, IL (US)

(72) Inventor: Thomas C. Erdman, Fort Atkinson, WI (US)

(21) Appl. No.: 16/886,210

(22) Filed: May 28, 2020

(51) Int. Cl. A47C 17/04; F16B 12/12

(52) U.S. Cl. CPC A47C 17/04; F16B 12/12

(57) ABSTRACT

Knock down sectional couches and related wedge sections and methods. In accordance with an example, a knock down wedge section for use with a sectional couch includes a wedge-shaped seat and a pair of back sections. The wedge-shaped seat having a front portion, a back portion including a first back portion and a second back portion, and lateral portions. Each of the first back portion and the second back portion carries a pair of male knock down bracket portions. Each back section carries a pair of female knock down bracket portions. Each female knock down bracket portion is adapted to receive and form a coupling with a corresponding male knock down bracket portion.

### FIELD OF THE DISCLOSURE

This disclosure relates generally to sectional couches and, in particular, to knock down sectional couches and related wedge sections and methods.

### BACKGROUND

Furniture may sometimes be manufactured and shipped as separate components and assembled by the customer or end user. However, the dimensions of certain furniture components such as sections of sectional couches may be larger than optimal standard shipping sizes and, thus, the components must typically be shipped in boxes that exceed the weight and/or size limits as defined by the UPS weight and size limits (2020) guidelines. Extra fees, referred to as an Over Maximum Limits charge, may be required when shipping containers that exceed the weight and/or size limits.

### SUMMARY

In accordance with a first example, a knock down sectional couch includes a left-side facing recliner, a knock down wedge section, an armless chair, a console, and a right-side facing recliner. The left-side facing recliner has a lateral portion carrying a left-side facing recliner lateral coupling component. The knock down wedge section includes a wedge-shaped seat and a pair of back sections. The wedge-shaped seat includes a front portion, a back portion including a first back portion and a second back portion, and lateral portions. Each of the first back portion and the second back portion carries a pair of male knock down brackets. Each of the lateral portions of the seat carry a seat lateral coupling component. Each back section carries a pair of female knock down brackets. Each female knock down bracket is adapted to receive and form a coupling with a corresponding one of the male knock down brackets. The armless chair has lateral portions. Each lateral portion of the armless chair carries an armless chair lateral coupling component. The console has lateral portions. Each lateral portion of the console carries a console lateral coupling component. The right-side facing recliner has a lateral portion carrying a right-side facing lateral coupling component. The left-side facing recliner lateral coupling component is adapted to be coupled to a corresponding seat lateral coupling component. One of the armless chair lateral coupling components is adapted to be coupled a corresponding seat lateral coupling component. One of the console lateral coupling components is adapted to be coupled to a corresponding armless chair lateral coupling component. The right-side facing recliner lateral coupling component is adapted to be coupled to a corresponding console lateral coupling component.

In accordance with a second example, a knock down wedge section for use with a sectional couch includes a wedge-shaped seat and a pair of back sections. The wedge-shaped seat having a front portion, a back portion including a first back portion and a second back portion, and lateral portions. Each of the first back portion and the second back portion carries a pair of male knock down bracket portions. Each back section carries a pair of female knock down bracket portions. Each female knock down bracket portion is adapted to receive and form a coupling with a corresponding male knock down bracket portion.

In accordance with a third example, a knock down wedge section for use with a sectional couch includes a first shipping container and a second shipping container, each of which are of dimensions small enough to not exceed the UPS weight and size limit (2020) guidelines. The first shipping container contains a wedge-shaped seat having a front portion, a back portion including a first back portion and a second back portion, and lateral portions. Each of the first back portion and the second back portion carries a pair of male knock down brackets. The second shipping container containing a pair of back sections. Each back section carries a pair of female knock down brackets. Each female knock down bracket is adapted to receive and form a coupling with a corresponding one of the male knock down brackets.

In accordance with a fourth example, a method of shipping a knock down wedge section for use with a sectional couch includes positioning a seat of the wedge section in a first shipping container of dimensions small enough to not exceed the UPS weight and size limit (2020) guidelines. The seat includes a first back portion and a second back portion. Each of the first back portion and the second back portion carries a pair of male knock down brackets. The method also includes positioning a pair of back sections of the wedge section in a second shipping container that is also of dimensions small enough to not exceed the UPS weight and size limit (2020) guidelines. Each back section carries a pair of female knock down brackets.

In further accordance with the foregoing first, second, third, and/or fourth examples, an apparatus and/or method may further include any one or more of the following:

In accordance with one example, the seat includes a seat base and a seat cushion. The seat base includes the first back portion and the second back portion. The male knock down brackets extend from an upward facing surface of the seat base. A step is formed between the seat base and the seat cushion.

In accordance with another example, the first back portion and the second back portion have corresponding back surfaces. The male knockdown brackets are positioned between the seat cushion and the corresponding back surfaces.

In accordance with another example, each back section includes a lateral portion including an inward facing surface carrying one of the female knock down brackets.

In accordance with another example, the corresponding male knock down brackets are inwardly spaced from the lateral portions of the seat.

In accordance with another example, each back section includes an inner portion including an inward facing surface carrying one of the female knock down bracket portions.

In accordance with another example, further including a rear skirt adapted to be coupled between the back portion and at least one of the back sections.

In accordance with another example, the rear skirt includes a first skirt portion and a second skirt portion. The first skirt portion being adapted to be coupled between the first back portion of the seat and one of the back sections. The second skirt portion being adapted to be coupled between the second back portion of the seat and one of the back sections.

In accordance with another example, the seat lateral coupling components include a male component and a female component.

In accordance with another example, the male component includes a protrusion having a protrusion body and a protrusion head and the female component includes a bracket defining a slot having an opening that is adapted to receive the protrusion body. The slot is sized to prevent the protrusion head from passing laterally through the slot.

In accordance with another example, the seat includes a seat base and a seat cushion. The seat base includes the first back portion and the second back portion and the male knock down brackets extend from an upward facing surface of the seat base. A step is formed between the seat base and the seat cushion.

In accordance with another example, each back section includes a lateral portion including an inward facing surface carrying one of the female knock down brackets.

In accordance with another example, the corresponding male knock down brackets are inwardly spaced from the lateral portions.

In accordance with another example, each of the first and second shipping containers is sized to not exceed the UPS weight and size limit (2020) guidelines.

In accordance with another example, each of the first and second shipping containers has a width of between approximately 84 centimeters and approximately 98 centimeters, a depth of approximately 35 centimeters and approximately 98 centimeters, and a height of approximately 50 centimeters and approximately 75 centimeters.

In accordance with another example, the first shipping container has a width of approximately 98 centimeters, a depth of approximately 98 centimeters, and a height of approximately 50 centimeters, and the second shipping container has a width of approximately 84 centimeters, a depth of approximately 35 centimeters, and a height of approximately 73 centimeters.

### BRIEF DESCRIPTION OF THE DRAWINGS

FIG. 1 is an isometric view of a knock down sectional couch in accordance with a first example of the present disclosure;

FIG. 2 is an expanded isometric view of the wedge section of the sectional couch of FIG. 1;

FIG. 3 is a detailed rear isometric view of the lateral back section portion of the back section of the sectional couch of FIG. 1;

FIG. 4 is a plan isometric view of the seat of the wedge section of the sectional couch of FIG. 1;

FIG. 5 is an isomeric view of the wedge section of the sectional couch of FIG. 1;

FIG. 6 is a rear view of the wedge section of the sectional couch of FIG. 1;

FIG. 7 is an isometric view of an example lateral coupling component that can be used with the sectional couch of FIG. 1;

FIG. 8 is an isometric view of an example lateral coupling component that can be used with the sectional couch of FIG. 1;

FIG. 9 is a plan isometric view of a shipping container that can be used to ship the seat of the sectional couch of FIG. 1;

FIG. 10 is a plan isometric view of the shipping container of FIG. 9 receiving the seat of the sectional couch of FIG. 1;

FIG. 11 is an isometric view of the shipping container of FIG. 9, closed with the seat contained therein;

FIG. 12 is a plan isometric view of the shipping container that can be used to ship the back sections of the sectional couch of FIG. 1;

FIG. 13 is a plan isometric view of the shipping container of FIG. 12, receiving the back sections; and

FIG. 14 illustrates the shipping container of FIG. 12, closed with the back sections contained therein.

### DETAILED DESCRIPTION

Although the following text discloses a detailed description of example methods, apparatus and/or articles of manufacture, it should be understood that the legal scope of the property right is defined by the words of the claims set forth at the end of this patent. Accordingly, the following detailed description is to be construed as examples only and does not describe every possible example, as describing every possible example would be impractical, if not impossible. Numerous alternative examples could be implemented, using either current technology or technology developed after the filing date of this patent. It is envisioned that such alternative examples would still fall within the scope of the claims.

Sectional couches sometimes include wedge sections that are difficult to ship in a container without the container being exceed the weight and/or size limits as defined by the UPS weight and size limits (2020) guidelines. Extra fees, referred to as an Over Maximum Limits charge, may be required when shipping containers that exceed the weight and/or size limits.

To avoid these extra fees, this disclosure is directed toward a knock down (KD) wedge section that can be used with a sectional couch. In some examples, the wedge section includes a seat and a pair of back sections that are attachable to the seat. To ship the wedge section, the seat may be positioned in a first shipping box and the pair of back sections may be positioned in a second shipping box, both of which are of dimensions small enough to not exceed the UPS weight and size limits (2020) guidelines.

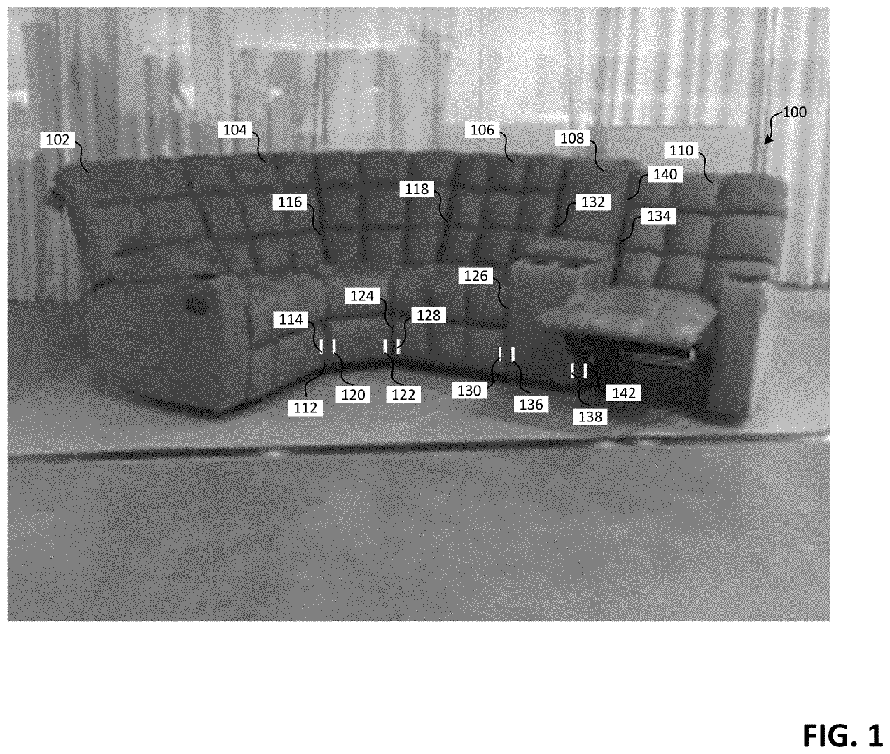

FIG. 1 is an isometric view of a knock down sectional couch 100 in accordance with a first example of the present disclosure. In the example shown, the sectional couch 100 includes a left-side facing recliner 102, a knock down wedge section 104, an armless chair 106, a console 108, and a right-side facing recliner 110.

The left-side facing recliner 102 has a lateral portion 112 carrying a left-side facing recliner lateral coupling component 114. The wedge section 104 has lateral portions 116, 118 carrying seat lateral coupling components 120, 122. The armless chair 106 has lateral portions 124, 126 carrying armless chair lateral coupling components 128, 130. The console 108 has lateral portions 132, 134 carrying corresponding console lateral coupling components 136, 138. Lastly, the right-side facing recliner 110 has a lateral portion 140 carrying a right-side facing lateral coupling component 142. In other words, one or more lateral coupling components are carried by the sections 102, 104, 106, 108, 112 of the sectional couch 100.

Adjacent ones of the lateral coupling components 114, 120, 122, 128, 130, 136, 138, and/or 142 are adapted to form lateral coupling component pairs 114 and 120, 122 and 128, 130 and 136, 138 and 142. Each lateral coupling component pair 114 and 120, 122 and 128, 130 and 136, 138 and 142 attach to one another to secure the components of the sectional couch 100 together. For example, a male/female connection may be formed between the lateral coupling component pairs 114, 120, 122, 128, 130, 136, 138, 142.

In the example shown, the left-side facing recliner lateral coupling component 114 is coupled to the seat lateral coupling component 120 on the left side of the wedge section 104 and the armless chair lateral coupling component 128 on the left side of the armless chair 106 is coupled the seat lateral coupling component 122 on the right side of the wedge section 104. Additionally, in the example shown, the console lateral coupling component 136 on the right side of the console 108 is coupled to the armless chair lateral coupling component 130 on the right side of the armless chair 106 and the right-side facing recliner lateral coupling component 142 is coupled to the console lateral coupling component 138 on the right side of the console 108.

The lateral coupling components 114, 120, 122, 128, 130, 136, 138, and/or 142 may be any type of bracket used to couple furniture components together. For example, the lateral coupling components 114, 120, 122, 128, 130, 136, 138, and/or 142 may be a bracket of an interlocking furniture connector, a snap style sectional connector, a protrusion, and/or a bracket having a slot adapted to receive the protrusion.

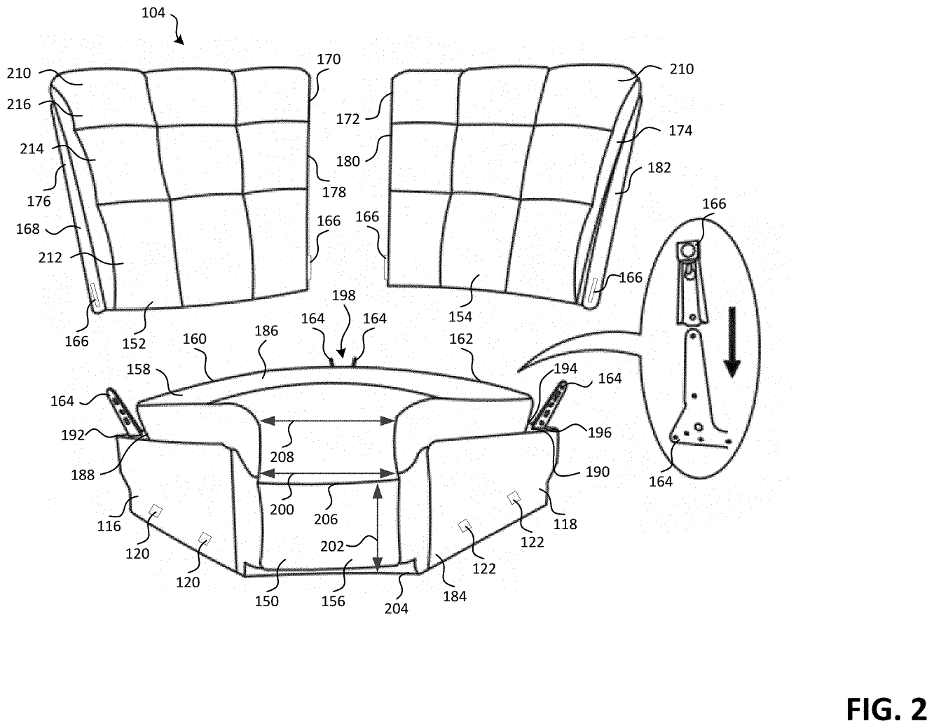

FIG. 2 is an expanded isometric view of the wedge section 104 of the sectional couch 100 of FIG. 1. In the example shown, the wedge section 104 includes a wedge-shaped seat 150 and a pair of back sections 152, 154. The seat 150 includes a front portion 156, a back portion 158, and the lateral portions 116, 118. The back portion 158 includes a first back portion 160 and a second back portion 162.

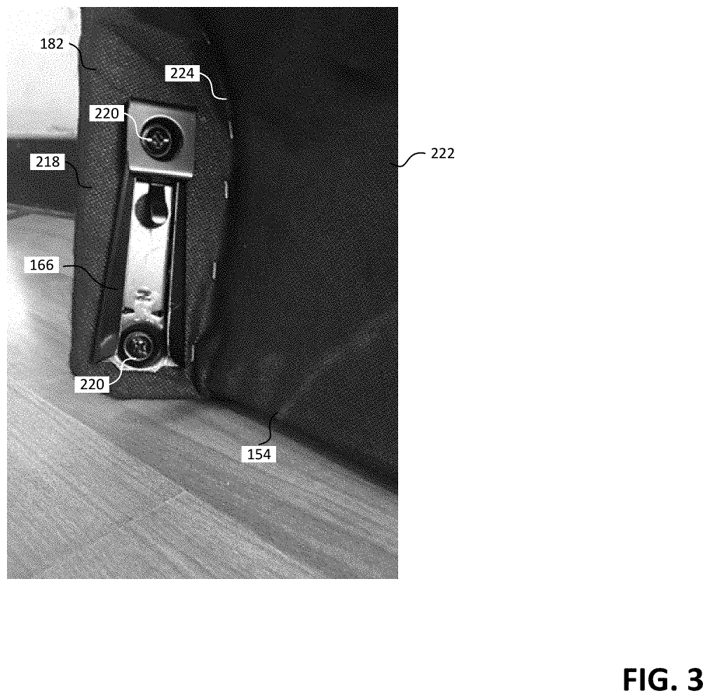

Each of the first back portion 160 and the second back portion 162 carry a pair of male knock down brackets 164. Each back section 152, 154 carries a pair of female knock down brackets 166. The female knock down brackets 166 are shown schematically in FIG. 2 being coupled to outward facing surfaces 168, 170, 172, 174 of lateral back section portions 176, 178, 180, 182 of the back section 152, 154. Alternatively, one or more of the female knock down brackets 166 may be coupled to inward facing surfaces of the lateral back section portions 176, 178, 180, 182 (the inward facing surface is shown more clearly in FIG. 3). In practice, each female knock down bracket 166 is adapted to receive and form a coupling with a corresponding one of the male knock down brackets 164.

As a result of the wedge section 104 including the pair of back sections 152, 154 that are separable from the seat 150, the back sections 152, 154 may be easily shipped in a first container and the seat 150 may be shipped in a second container. As disclosed in more detail below, each of the containers may be of dimensions sufficiently small so as to not exceed the UPS weight and size limits (2020) guidelines. As an example, a package may be considered to exceed the size limits when the length and girth of the package combined exceeds 165 inches and/or if the length of the package exceeds 108 inches.

Still referring to FIG. 2, the seat 150 includes a seat base 184 and a seat cushion 186. The seat base 184 includes the first back portion 160 and the second back portion 162. A step 188 is formed between the seat base 184 and the seat cushion 186. When the back sections 152, 154 are coupled to the seat 150, lower portions of the back sections 152, 154 are received within the step 188.

In the example shown, the male knock down brackets 164 extend from an upward facing surface 190 of the seat base 184. Alternatively, the male knock down brackets 164 may be coupled to the lateral portions 116, 118 of the lateral wedge section 104.

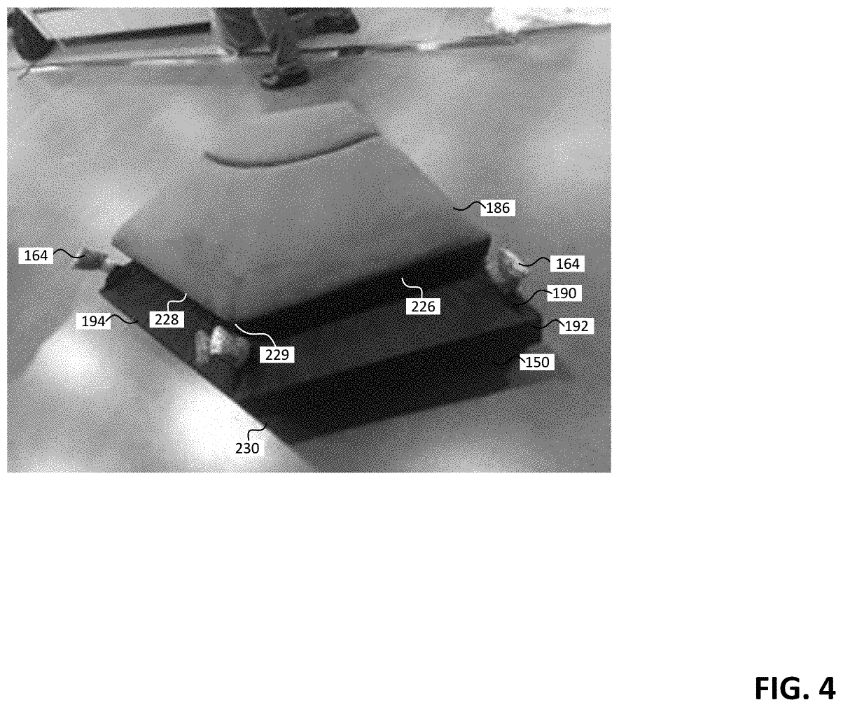

The first back portion 160 and the second back portion 162 have corresponding back surfaces 192, 194 (the back surfaces 192, 194 are more clearly shown in FIG. 4). The back surfaces 192, 194 extend downward from the upward facing surface 190 of the seat base 184 toward the ground. The male knock down brackets 164 are positioned between the seat cushion 186 and the corresponding back surfaces 192, 194. The male knock down brackets 164 are also inwardly spaced from the lateral portions 116, 118 of the seat 150.

A space 196 is provided between the lateral portions 116, 118 of the seat 150 and the corresponding male knock down brackets 164. When the back sections 152, 154 are coupled to the seat 150, outer ones of the lateral back section portions 176, 182 may be positioned within the space 196 (see, for example, FIG. 5).

Similarly, in the example shown, a space 198 is positioned between central ones of the male knockdown brackets 164. When the back sections 152, 154 are coupled to the seat 150, inner ones of the lateral back portions 178, 180 may be positioned within the space 198.

In the example shown, the front portion 156 has a central width 200 of approximately 13.5 inches. A height 202 from a lower seat surface 204 to a seam 206 of the front portion 156 of the seat 150 is approximately 10.5 inches. The front portion 156 of the seat 150 has an upper width 208 of approximately 14 inches. The central width 200, the height 202, and/or the upper width 208 may be any other dimension depending on the application, the size of the sectional couch 100, and/or other considerations.

The back sections 152, 154 have back section cushions 210. The back section cushions 210 include lower, middle, and upper cushion sections 212, 214, 216. In the illustrated example, the lower cushion sections 212 have a lesser width than the middle cushion sections 214 and the middle cushion sections 214 have a lesser width than the upper cushion sections 216. As a result of the sizing of the cushion sections 212, 214, 216, at least one of the lateral back section portions 176, 178 may taper outwardly.

In the example shown, the cushion sections 212, 214, 216 are rectangular. However, the cushion sections 212, 214, 216 may be any other shape (e.g., circular, oblong). The middle cushion sections 214 may have a width of approximately 9.5 inches and may have a height of approximately 9 inches. The upper cushion section 216 may have a width of approximately ten inches and a height of approximately 7.5 inches. The size and/or shape of the cushion sections 212, 214, 216 may be changed. Alternatively, the cushion sections 212, 214, 216 may be omitted to allow for the back section 152 to have a different style.

FIG. 3 is a detailed rear isometric view of the lateral back section portion 182 of the back section 154 of the sectional couch 100 of FIG. 1. In the example shown, the lateral back section portion 182 includes an inward facing surface 218. The inward facing surface 218 carries one of the female knock down brackets 166. The female knock down bracket 166 is coupled to the inward facing surface 218 using fasteners 220. The other female knock down brackets 166 may be coupled to inward facing surfaces of the other lateral back section portions 176, 178, 180.

The back section 154 also includes a back wall 222. The lateral back section portion 182 intersects the back wall 222 at an interface 224.

FIG. 4 is a plan isometric view of the seat 150 of the wedge section 104 of the sectional couch 100 of FIG. 1. The seat cushion 186 includes rear seat cushion surfaces 226, 228. In the example shown, the rear seat cushion surfaces 226, 228 are substantially parallel to the back surfaces 192, 194 of the seat 150.

The rear seat cushion surfaces 226, 228 meet at a vertical edge 229 and the back surfaces 192, 194 meet at a vertical edge 230. The vertical edges 229, 230 are substantially co-planar. However, the rear seat cushion surfaces 226, 228 and the back surfaces 192, 194 may be differently arranged and/or have a different contour (e.g., curved). For example, the rear seat cushion surfaces 226, 228 may be approximately 90° relative to one another or may form a curved surface.

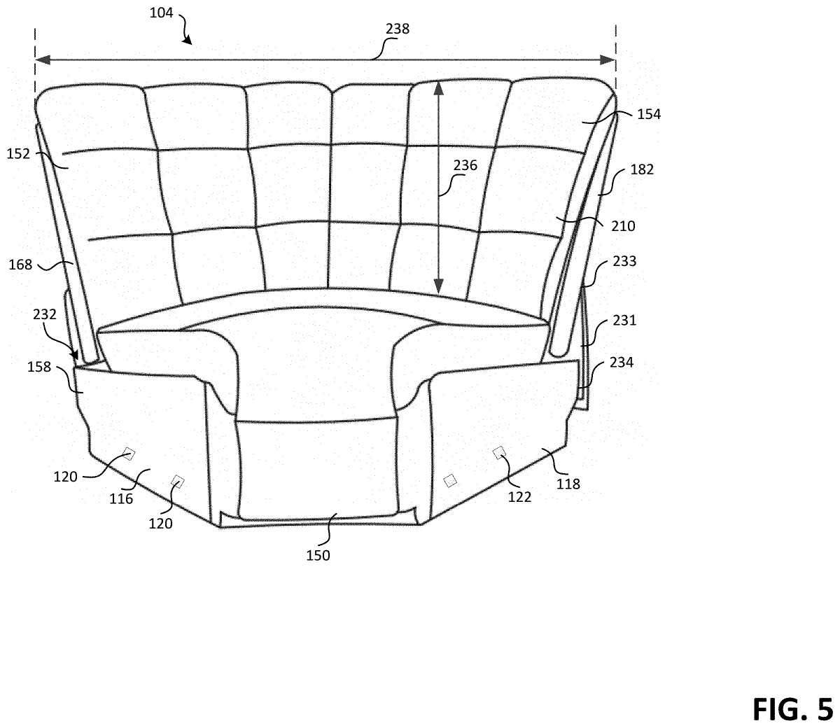

FIG. 5 is an isomeric view of the wedge section 104 of the sectional couch 100 of FIG. 1. In the example shown, a rear skirt 231 is included. The rear skirt 231 is coupled between the back portion 158 and at least one of the back sections 152, 154. The rear skirt 231 may cover an interface 232 between the back portion 158 and the back sections 152, 154 (shown more clearly in FIG. 6). Thus, the coupling between the male and female knock down brackets 164, 166 may be covered by the rear skirt 231 and, thus, may be less or not visible.

The rear skirt 231 may be coupled to one of the back sections 152, 154 using a first coupling 233 and may be coupled to the back portion 158 using a second coupling 234. The first coupling 233 may be a permanent coupling such as a tack(s), a nail(s), stitching, or adhesive (e.g., fabric adhesive). The second coupling 234 may be a releasable coupling such as a hook-and-loop fastener and/or a snap faster. However, the first coupling 233 may be a releasable coupling and/or the second coupling 234 may be a permanent coupling.

In the example shown, a height 236 of the back section cushion 210 is approximately 24.5 inches and an upper width 238 of the back sections 152, 154 is approximately 61.5 inches. However, the height 236 and/or the upper width 238 may be any other dimension depending on the application, the size of the sectional couch 100, and/or other considerations. For example, the wedge section 104 may have a width of approximately 62.5 inches, a depth of approximately 37 inches, and a height of approximately 38.5 inches.

FIG. 6 is a rear view of the wedge section 104 of the sectional couch 100 of FIG. 1. In the example shown, the rear skirt 231 includes a first skirt portion 240 and a second skirt portion 242. The first skirt portion 240 is coupled between the first back portion 160 and the back section 152 and the second skirt portion 242 is coupled between the second back portion 162 and the back section 154.

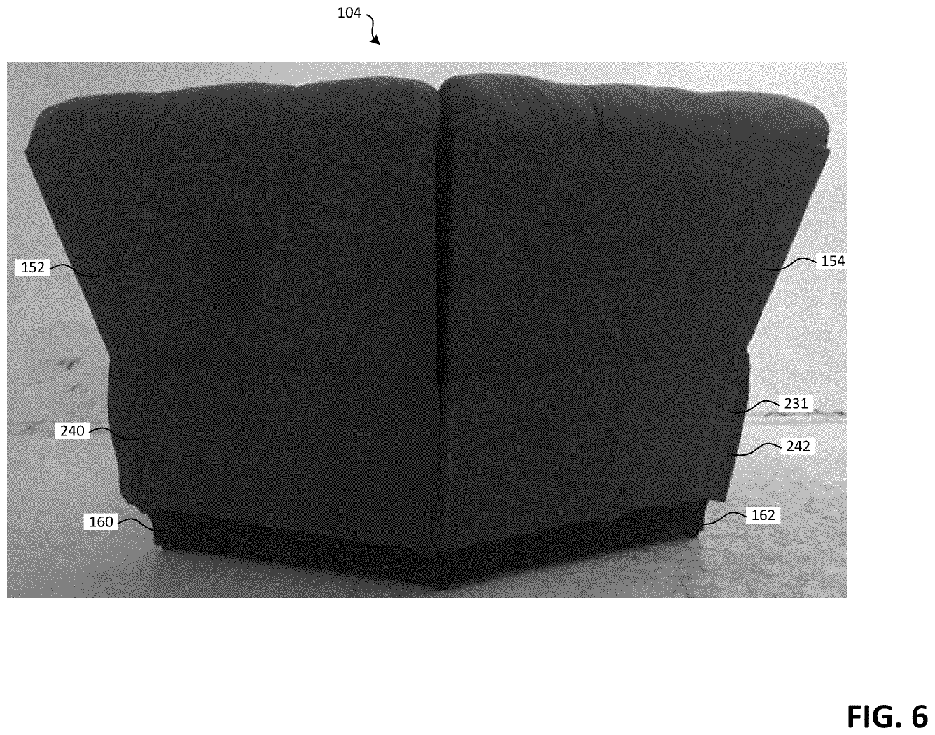

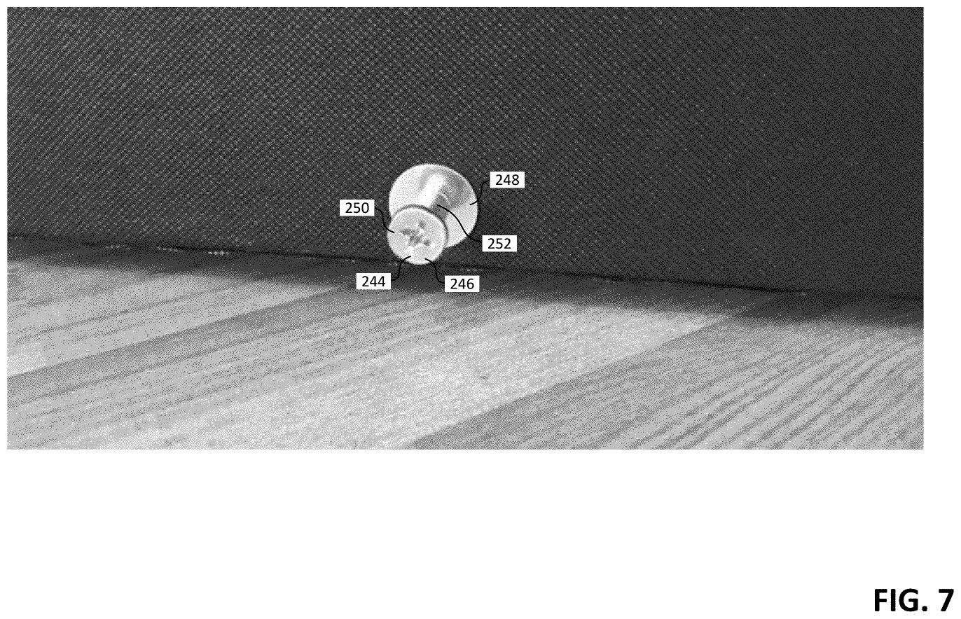

FIG. 7 is an isometric view of an example lateral coupling component 244 that can be used with the sectional couch 100 of FIG. 1. The lateral coupling component 244 of FIG. 7 can be used to implement one of the lateral coupling components of the lateral coupling component pairs 114 and 120, 122 and 128, 130 and 136, 138 and 142 of the sectional couch 100, for example.

The lateral coupling component 244 of FIG. 7 is a male component 246. In the example shown, the male component 246 includes a protrusion 248. The protrusion 248 includes a protrusion head 250 and a protrusion body 252.

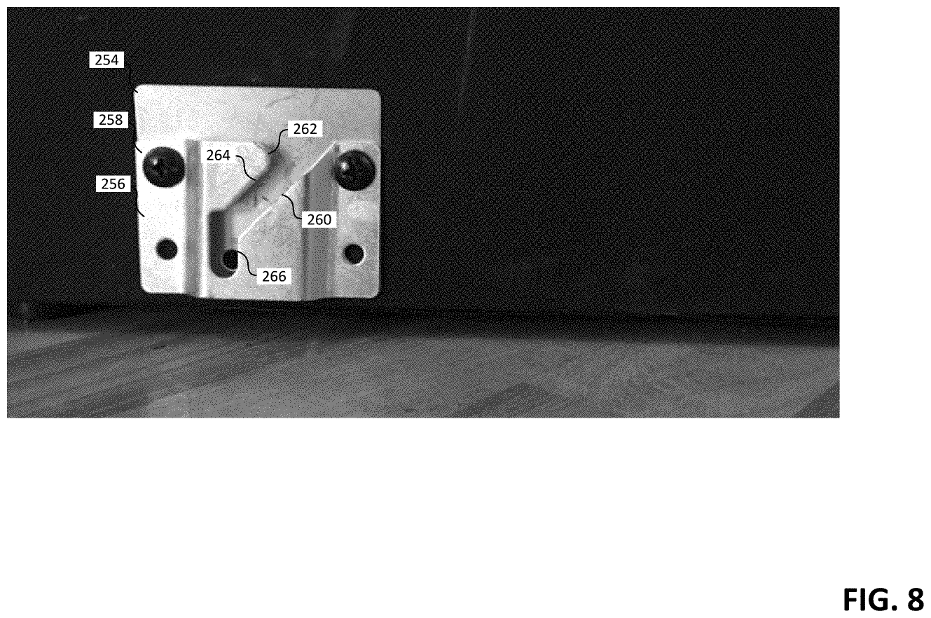

FIG. 8 is an isometric view of an example lateral coupling component 254 that can be used with the sectional couch 100 of FIG. 1. The lateral coupling component 254 of FIG. 8 can be used to implement the other one of the lateral coupling components of the lateral coupling component pairs 114 and 120, 122 and 128, 130 and 136, 138 and 142, for example. The lateral coupling component 254 of FIG. 8 is complementary to the lateral coupling component 244 of FIG. 7.

The lateral coupling component 254 of FIG. 8 is a female component 256. In the example shown, the female component 256 includes a bracket 258 defining a slot 260 having an opening 262. The slot 260 includes a tapered portion 264 and a vertical portion 266. The opening 262 is adapted to receive the protrusion body 252 of the protrusion 248 of FIG. 7 and the slot 260 is sized to prevent the protrusion head 250 of the protrusion 248 of FIG. 7 from passing laterally through the slot 260.

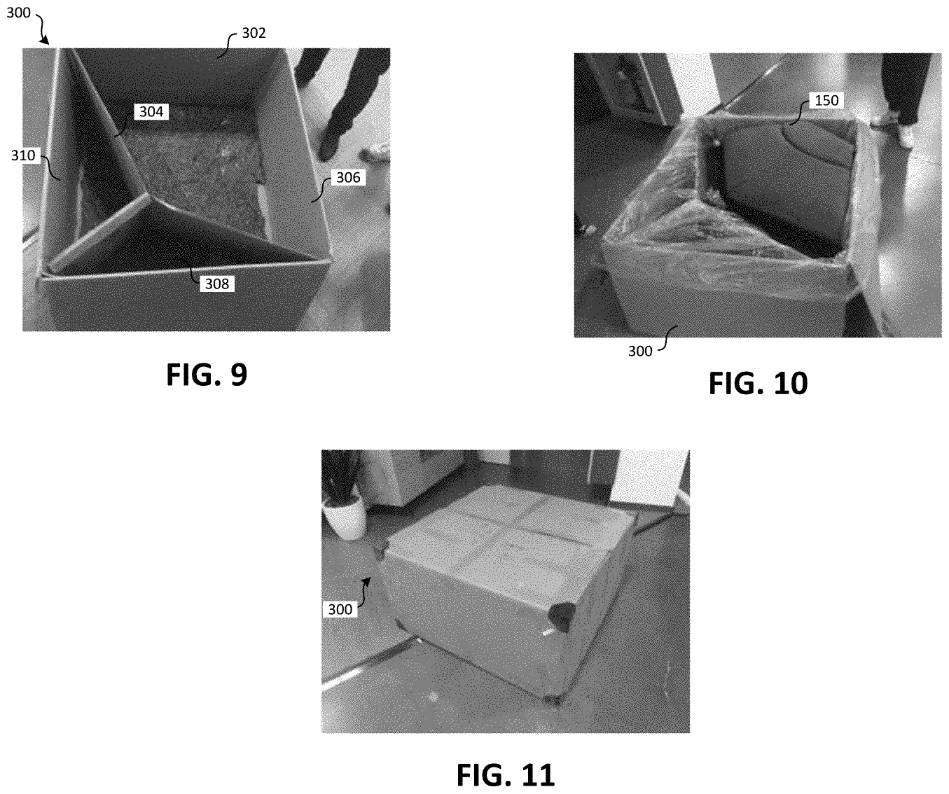

FIGS. 9-11 depict the process of placing the wedge-shaped seat 150 in a shipping container 300.

FIG. 9 is a plan isometric view of the shipping container 300 that that can be used to ship the seat 150 of the sectional couch 100 of FIG. 1. In the example shown, the shipping container 300 has a width of between approximately 84 centimeters and approximately 98 centimeters, a depth of approximately 35 centimeters and approximately 98 centimeters, and a height of approximately 50 centimeters and approximately 75 centimeters. More specifically, in the example shown, the shipping container 300 has a width of approximately 98 centimeters, a depth of approximately 98 centimeters, and a height of approximately 50 centimeters.

The shipping container 300 defines a space 302 and contains a divider 304. The divider 304 divides the space 302 into a first compartment 306, a second compartment 308, and a third compartment 310. The first compartment 306 is sized to receive the seat 150.

FIG. 10 is a plan isometric view of the shipping container 300 of FIG. 8 receiving the seat 150 of the sectional couch 100 of FIG. 1.

FIG. 11 is an isometric view of the shipping container 300 of FIG. 8, closed with the seat 150 contained therein.

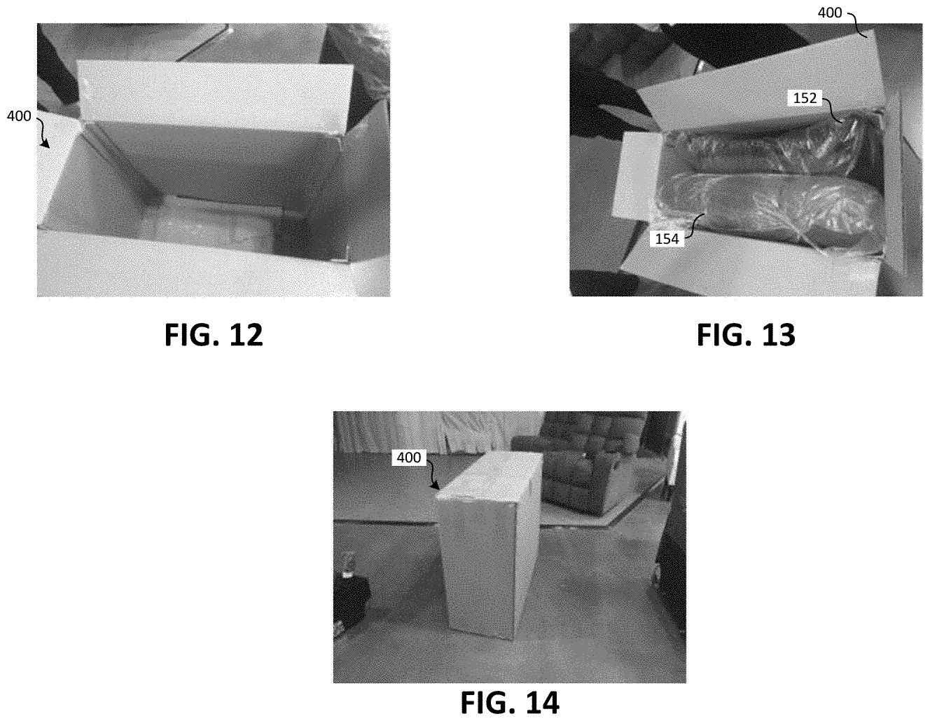

FIGS. 12-14 depict the process of placing the back sections 152, 154 in a shipping container 400.

FIG. 12 is a plan isometric view of the shipping container 400 that can be used to ship the back sections 152, 154 of the sectional couch 100 of FIG. 1. In the example shown, the shipping container 400 has a width of between approximately 84 centimeters and approximately 98 centimeters, a depth of approximately 35 centimeters and approximately 98 centimeters, and a height of approximately 50 centimeters and approximately 75 centimeters. More specifically, in the example shown, the shipping container 400 has a width of approximately 84 centimeters, a depth of approximately 35 centimeters, and a height of approximately 73 centimeters.

FIG. 13 is a plan isometric view of the shipping container 400 of FIG. 12, receiving the back sections 152, 154.

FIG. 14 illustrates the shipping container 400 of FIG. 12, closed with the back sections 152, 154 contained therein.

Further, while several examples have been disclosed herein, any features from any examples may be combined with or replaced by other features from other examples. Moreover, while several examples have been disclosed herein, changes may be made to the disclosed examples without departing from the scope of the claims.

1. A knock down sectional couch, comprising:
a left-side facing recliner having a lateral portion carrying a left-side facing recliner lateral coupling component;
a knock down wedge section, comprising:
a wedge-shaped seat having a front portion, a back portion including a first back portion and a second back portion, and lateral portions, each of the first back portion and the second back portion carrying a pair of male knock down brackets, each of the lateral portions of the seat carrying a seat lateral coupling component; and
a pair of back sections, each back section carrying a pair of female knock down brackets, each female knock down bracket adapted to receive and form a coupling with a corresponding one of the male knock down brackets;
an armless chair having lateral portions, each lateral portion of the armless chair carrying an armless chair lateral coupling component;
a console having lateral portions, each lateral portion of the console carrying a console lateral coupling component; and
a right-side facing recliner having a lateral portion carrying a right-side facing lateral coupling component,
the left-side facing recliner lateral coupling component adapted to be coupled to a corresponding seat lateral coupling component, one of the armless chair lateral coupling components adapted to be coupled a corresponding seat lateral coupling component, one of the console lateral coupling components adapted to be coupled to a corresponding armless chair lateral coupling component, and the right-side facing recliner lateral coupling component adapted to be coupled to a corresponding console lateral coupling component.

2. The knock down sectional couch of claim 1, wherein the seat includes a seat base and a seat cushion, wherein the seat base includes the first back portion and the second back portion and the male knock down brackets extend from an upward facing surface of the seat base, a step is formed between the seat base and the seat cushion.

3. The knock down sectional couch of claim 2, wherein the first back portion and the second back portion have corresponding back surfaces, and wherein the male knockdown brackets are positioned between the seat cushion and the corresponding back surfaces.

4. The knock down sectional couch of claim 1, wherein each back section includes a lateral portion including an inward facing surface carrying one of the female knock down brackets.

5. The knock down sectional couch of claim 4, wherein the corresponding male knock down brackets are inwardly spaced from the lateral portions of the seat.

6. The knock down sectional couch of claim 1, wherein each back section includes an inner portion including an inward facing surface carrying one of the female knock down bracket portions.

7. The knock down sectional couch of claim 1, further comprising a rear skirt adapted to be coupled between the back portion and at least one of the back sections.

8. The knock down sectional couch of claim 7, wherein the rear skirt comprises a first skirt portion and a second skirt portion, the first skirt portion being adapted to be coupled between the first back portion of the seat and one of the back sections, the second skirt portion being adapted to be coupled between the second back portion of the seat and one of the back sections.

9. The knock down sectional couch of claim 1, wherein the seat lateral coupling components include a male component and a female component.

10. The knock down sectional couch of claim 9, wherein the male component includes a protrusion having a protrusion body and a protrusion head and the female component includes a bracket defining a slot having an opening that is adapted to receive the protrusion body, the slot being sized to prevent the protrusion head from passing laterally through the slot.

11. A knock down wedge section for use with a sectional couch, comprising:
a wedge-shaped seat having a front portion, a back portion including a first back portion and a second back portion, and lateral portions, each of the first back portion and the second back portion carrying a pair of male knock down bracket portions; and
a pair of back sections, each back section carrying a pair of female knock down bracket portions, each female knock down bracket portion adapted to receive and form a coupling with a corresponding male knock down bracket portion.

12. The knock down wedge section of claim 11, wherein the seat includes a seat base and a seat cushion, wherein the seat base includes the first back portion and the second back portion and the male knock down bracket portions extend from an upward facing surface of the seat base, a step is formed between the seat base and the seat cushion.

13. The knock down wedge section of claim 11, wherein each back section includes a lateral portion including an inward facing surface carrying one of the female knock down brackets.

14. The knock down wedge section of claim 13, wherein the corresponding male knock down brackets are inwardly spaced from the lateral portions.

15. The knock down wedge section of claim 11, wherein each back section includes an inner portion including an inward facing surface carrying one of the female knock down brackets.

16. A knock down wedge section for use with a sectional couch, comprising:
a first shipping container containing a wedge-shaped seat having a front portion, a back portion including a first back portion and a second back portion, and lateral portions, each of the first back portion and the second back portion carrying a pair of male knock down brackets; and
a second shipping container containing a pair of back sections, each back section carrying a pair of female knock down brackets, each female knock down bracket adapted to receive and form a coupling with a corresponding one of the male knock down brackets.

17. The knock down wedge section of claim 16, wherein each of the first and second shipping containers is sized to not exceed the UPS weight and size limit (2020) guidelines.

18. The knock down wedge section of claim 16, wherein each of the first and second shipping containers has a width of between approximately 84 centimeters and approximately 98 centimeters, a depth of between approximately 35 centimeters and approximately 98 centimeters, and a height of between approximately 50 centimeters and approximately 75 centimeters.

19. A method of shipping a knock down wedge section for use with a sectional couch, comprising:
positioning a seat of the wedge section in a first shipping container, the seat including a first back portion and a second back portion, each of the first back portion and the second back portion carrying a pair of male knock down brackets; and
positioning a pair of back sections of the wedge section in a second shipping container, each back section carrying a pair of female knock down brackets.

20. The method of claim 19, wherein the first shipping container has a width of approximately 98 centimeters, a depth of approximately 98 centimeters, and a height of approximately 50 centimeters, and the second shipping container has a width of approximately 84 centimeters, a depth of approximately 35 centimeters, and a height of approximately 73 centimeters.
